(19) United States
(12) Patent Application Publication
(10) Pub. No.: US 2008/0289546 A1
(43) Pub. Date: Nov. 27, 2008

(54) SAFE WITH ELECTRONIC STORAGE

(76) Inventor: Ranbir Kandola, Northborough, MA (US)

Correspondence Address: LAW OFFICE OF BRETT N. DORNY, 386 WEST MAIN STREET, SUITE 12A, NORTHBOROUGH, MA, 01532, US

(21) Appl. No.: 11/753,809

(22) Filed: May 25, 2007

(51) Int. Cl. E05G 1/00

(52) U.S. Cl. 109/23

(57) ABSTRACT

A secure enclosure includes an information storage device within an inner compartment. The secure enclosure has an opening within a wall. A communications interface connected to the information storage device extends within the opening. The communication interface allows the information storage device to be connected to a computer or network for receipt and storage of electronic information. The secure enclosure is used to store other items with the information storage device.

### BACKGROUND OF THE INVENTION

1. Field of the Invention

The present invention relates generally to a secure enclosure for storing materials. More particularly, it relates to a secure enclosure with an electronic communication interface for storage of electronic information.

2. Description of Related Art

With the introduction of computers, a need developed for reliably storing computer generated information. Normally, computers or other electronic computational devices are connected with and communicate directly with information storage devices. These information storage devices exist in several types including: hard disk drives, floppy disk drives, CD or DVD drives, and flash memory. When in use, these information storage devices connect with computers or other electronic computational devices via various types of interfaces including: electrical cables, optical cables or wireless transmissions. The information storage devices may be used as primary storage of information or to backup data stored elsewhere.

Typically, the information storage devices are located in or near the computer. Such locations are not secure. The devices may be easily stolen, lost, damaged, or destroyed. In order to protect the information, when not in use, information storage devices may be disconnected and stored in a secure places. Alternatively, for storage devices with removable media, the media may be removed and stored in a secure location.

With the increased use of electronically stored information, securing and protecting this type of information from theft, destruction by fire, or from other environmental degradation has become important. Theft of physical electronic storage devices or removable media has resulted in the loss of valuable business and personal information. Fires have destroyed storage devices sometimes resulting in the loss of critical information. The loss of critical information may result in significant loss of time, business, profits or other types of losses.

Historically, secure enclosures, such as safes and safety deposit boxes have been used to protect valuable property, including personal items such as currency, jewels, important documents and personal heirlooms from theft, fire or other environmental damage. A key or combination lock is used to keep the enclosure properly secure. The walls of the enclosure are designed to prevent unauthorized entry. Often, such enclosures are of a weight which prevents theft of the enclosure. Secure enclosures have also been used to store business documents or other important items relating to businesses. More recently, removable media and/or removable electronic storage devices have been stored in a safe or other secure enclosure. The complicated process of opening the safe in order to store or retrieve electronic data prevents its common use. Electronic data is constantly changing. In order to keep the information in the safe current, the safe has to be repeatedly opened and accessed.

In addition to the above mentioned secure enclosures, other less secure enclosures such as thin metal key locked enclosures or fastener secured enclosure are known in the art to provide a minimal level of security against theft of important electronically or optically stored information. Rooms designed to protect information stored electronically or optically from being destroyed by fire are also known in the art. None of these devices easily accommodate electronic information.

Several types of devices combining electronics with a secure enclosure exist and have been patented. One such secure device consists of an enclosure with a door and bionic activated electronic locking device requiring information such as a finger print or eye image to open. Electronic devices are used to manipulate the door. Another device is a safe designed to securely store a loaded gun. The inside of the safe contains a mounting bracket. The safe may be opened using several types of electronically activated interfaces attached to the locking mechanisms including bionic information, or a keypad. An alarm may sound when an attempt is made to open the safe. Yet, even another device consists of a set of electronic managed locking devices for securing one or more filing cabinets. The electronic devices including keypads for entering lock opening information. All of these devices use electronic devices and connections attached directly to and for the sole purpose of manipulating the enclosure locking mechanisms and for recording information about the locking mechanisms. No such devices include devices for storing electronic information.

Therefore, a need exists for a secure enclosure for simply storing electronic information. A need exists for a secure enclosure capable of directly interfacing with a computer or other electronic computational device. A need exists for a fire proof secure storage device, prevents loss and damage of electronic information.

### SUMMARY OF THE INVENTION

The present invention provides a secure enclosure for storing electronic information. According to one aspect of the invention, it includes a secure enclosure with an electronic storage device enclosed therein. According to another aspect of the invention, the secure enclosure includes a communication interface penetrating a wall of the enclosure to access the electronic storage device. According to another aspect of the invention, the communication interface includes a door to close the wall of the enclosure. According to another aspect of the invention, the secure enclosure is fire-proof. According to another aspect of the invention, the secure enclosure is sized to allow for storage of additional items with the electronic storage device.

### BRIEF DESCRIPTION OF THE DRAWINGS

FIG. 1 is a perspective view of a secure enclosure according to an embodiment of the present invention.

### DETAILED DESCRIPTION

The present invention now will be described more fully hereinafter with reference to the accompanying drawings, which are intended to be read in conjunction with both this summary, the detailed description and any preferred and/or particular embodiments specifically discussed or otherwise disclosed. This invention may, however, be embodied in many different forms and should not be construed as limited to the embodiments set forth herein: rather, these embodiments are provided by way of illustration only and so that this disclosure will be thorough, complete and will fully convey the full scope of the invention to those skilled in the art.

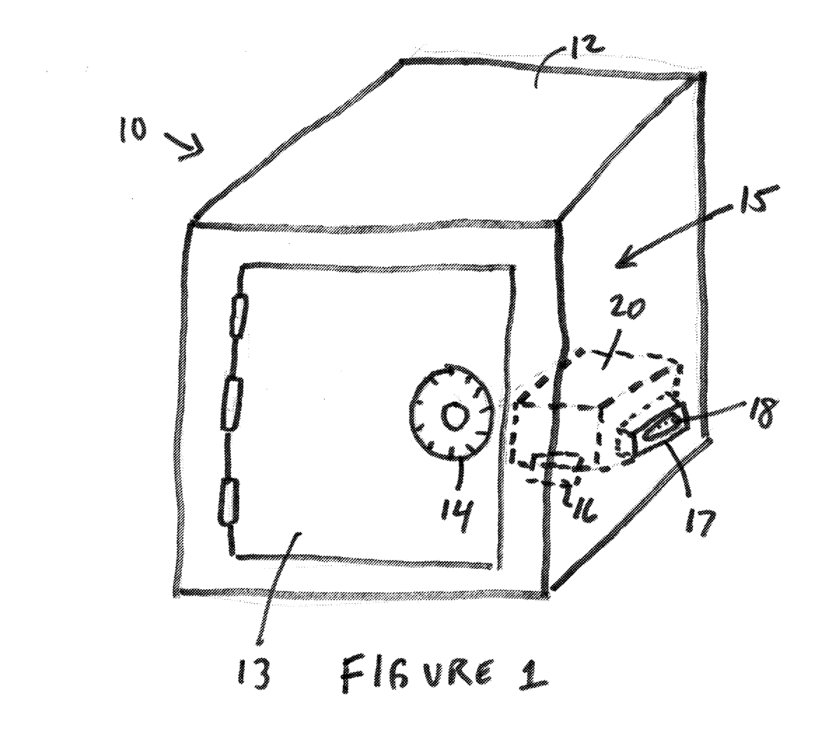

FIG. 1 illustrates an embodiment of the present invention. This embodiment includes a secure enclosure 10 such as a wall safe, or floor safe, or thick wall metallic box. The secure enclosure 10 is generally of typical construction including a door 13; a locking mechanism with interface 14, an outer surface 12, and an internal compartment 15.

An information storage device 20 is located within the internal compartment 15 of the secure enclosure 10. The information storage device 20 may be of any known type for storing electronic data, including a hard disk drive, tape drive, floppy disk drive, CD or DVD drive, or flash memory. A bracket 16 may be located inside the compartment 15 for retaining the information storage device 20 within the secure enclosure 10. An opening 17 is formed in the outer surface 12 of the secure enclosure. A communications interface 18 penetrates through the opening 17 to provide access to the information storage device 20. The communications interface 18 may be made of any electrical conducting material such as copper, or silver, or other metallic material. In addition, the communications interface 18 may be made from fiber optic material or wireless technology. In the embodiment shown in FIG. 1, the communication interface 18 is a connection which ends in the opening 17. However, other embodiments are possible. The communications interface 18 may be a cable or wire which extends from the opening 17. In such a case, the opening 17 can be just large enough to accommodate the cable. It may also be of various known communication connectors, such as an Ethernet, serial, parallel, IDE, SCSI or USB connection. The connector may be positioned within or on either side of the opening 17. A door or cover (not shown) may be used to seal the opening 17 when the communications interface 18 is not in use.

The information storage device 20 is accessed through the communications interface 18 without having to open the door 13 of the secure enclosure 10. It may be connected to a computer or other processing device. Alternatively, it may be connected to a computer network. The connection may be continuous or transient. Information may be transferred to the information storage device 20 constantly or at set or periodic times.

The secure enclosure 10 is sized so that the interior compartment 15 can hold at least the information storage device 20. Preferably, the secure enclosure 10 is large enough to permit other items to be stored in the interior compartment 15. Thus, it can function as a standard safe, as well as storing electronic information.

1. A secure storage device comprising:
a secure enclosure including:
a plurality of sides;
a door which is moveable between an open position and a closed position relative to the plurality of sides, the door being lockable in the closed position, wherein the plurality of sides and door, when in the closed position, are arranged to form an enclosed inner compartment therebetween; and
an opening within at least one of the plurality of sides;
an information storage device within the inner compartment; and
a communications interface connected to the information storage device, at least partially positioned in the opening of the secure enclosure, to allow access to data in the information storage device from outside the secure enclosure when the door is in the closed position.

2. The secure device of claim 1 wherein the secure enclosure is fire proof.

3. The secure device of claim 1 wherein the secure enclosure limits a temperature of the inner compartment.

4. The secure device of claim 1 further comprising:
a mounting bracket attached to a surface of the inner compartment of the secure enclosure and to the information storage device.

5. The secure device of claim 1 wherein the inner compartment is larger than the information storage device.

6. The secure device of claim 1 wherein the communications interface includes a connector positioned within the opening of the secure enclosure.

7. The secure device of claim 1 wherein the communications interface includes a communication wire extending through the opening and having one end connected to the information storage device for communication.
